(19) United States
(12) Patent Application Publication
(10) Pub. No.: US 2002/0074305 A1
(43) Pub. Date: Jun. 20, 2002

(54) Portable and towable lift mechanism attachable to a front end loader

(76) Inventors: Stacia G. Davis, Bath, OH (US); Bill Blanton, Massillon, OH (US); Aaron Fockler, New Philadelphia, OH (US)

Correspondence Address: John M. Vasuta, 7570 Hudson Park Drive, Hudson, OH, 44236, US

(21) Appl. No.: 09/827,765

(22) Filed: Apr. 6, 2001

Related U.S. Application Data
(60) Provisional application No. 60/061,410, filed on Oct. 3, 1997.

(51) Int. Cl. B66C 23/44

(52) U.S. Cl. 212/180; 212/301

(57) ABSTRACT

An improved lift mechanism that is portable and towable, and is attachable to a front end loader such as a skid steer™ and has a telescopic and angularly adjustable load carrying boom. The lift may be pivotable about the front end loader to allow for better positioning and use of it.

### CROSS REFERENCE

This application claims priority from U.S. patent application Ser. No. 09/433,831, filed on Nov. 3, 1999, which claimed priority from U.S. patent application Ser. No. 09/165,664, filed on Oct. 3, 1998, and U.S. Provisional Patent Application No. 60/061,410, filed on Oct. 3, 1997.

### BACKGROUND OF THE INVENTION

1. Technical Field

The present invention relates to cranes or lifts. More particularly, the present invention relates to portable and towable cranes or lifts that are attachable to a front end loader or the like such as a skid steer™ while also being capable of safely lifting thousands of pounds and/or telescoping to distances approaching or beyond 30 feet at angles of between substantially horizontal to almost vertical as well as being capable of compact storage for towing. Specifically, the present invention is a portable and towable lift mechanism attachable to a front end loader where the lift mechanism includes a telescopic and angularly adjustable load carrying boom, telescopic support legs with pivotable wheels thereon, and a low center of gravity frame.

2. Background Information

For hundreds of years, people have needed and/or desired to lift or move heavy or bulky objects. More particularly, people have needed and/or desired to vertically or substantially vertically lift heavy or bulky objects up into the air, to suspend heavy or bulky objects angularly outward and at least slightly in the air, or to both lift and suspend the object. Often these needs occur for one of two reasons, a bulky and/or heavy object either (1) needs lifted into the air for a temporary time or to be placed on a surface or suspended from a frame in the air, or (2) needs lifted over an obstacle and set down on the other side.

Current technology includes large relatively or completely immobile cranes. These cranes are generally used on construction sites where the crane is transported via trailer by large trucks such as tractor-trailers. These large cranes are expensive to own or rent, not portable or hard and time consuming to move, not towable as trailering is typically necessary, not readily transported to remote sites, not easily positioned as needed in tight spots (often not possible), etc.

Alternatively, many manufacturers of cranes, lifts, and hoists have attempted to downsize this large crane technology to a smaller, more affordable, and user friendly lift. The result is often an unstable, dangerous, and otherwise undesirable lift that includes an insufficient frame for supporting substantial loads. Theses small lifts are often sufficient for small jobs such as lifting car engines weighing several hundred pounds, but are generally not capable of lifting substantial weights of approaching if not exceeding a thousand pounds, if not more. These booms often are inferior and hard to use, and may be capable of lifting only a small weight safely. Finally, these lifts either have fixed booms or extendible booms of only a small distance such as a few feet upwards to approximately ten feet.

In certain situations these relatively or completely immobile cranes as mentioned above cannot be positioned as is needed by the user, or rapidly positioned as needed, or moved from one position to another on a job site as is often readily needed, or rapidly moved back and forth as needed to repetitively move objects, or adjusted to the needed height or angle or other position as needed. In addition, the downsized cranes and lifts as mentioned above are often insufficiently framed to support or carry significant loads, not quickly and/or readily movable due to lack of steering and drive components, and not of sufficient weight to lift heavy loads.

### SUMMARY OF THE INVENTION

The present invention is an improved crane, lift or hoist that is attachable to a typical vehicle, such as a front end loader or skid steer loader, that is present on many job sites such as construction sites, farms, landscaping jobs, etc. The improved crane, lift or hoist is attachable to a standard front end loader, and is portable and towable at highway speeds when disconnected from the front end loader. It includes a frame having a hitch and wheels for towing thereon as well as a boom with a lift hook or the like on a distal end thereof.

In one embodiment, the improved crane, lift or hoist is attachable to a front end loader via an attachment plate that is meant to mate with an attachment portion of the front end loader. The lift may also further be of a retractable size equivalent to a standard vehicle tow behind trailer of an approximately 6 to 8 foot width (a width that does not require wide load designation and have limited transportation due to road and daylight restrictions) and approximately 8 to 12 foot length (standard trailer length) such that it is stable during both towing and fully extended use. The lift is extendible to approximately between 8 and 12 feet in width and approximately between 10 and 16 feet in length and is capable of safely lifting thousands of pounds. It includes a boom that may be of a telescoping, at least partially hydraulic, nature that is capable of retraction to between approximately 6 and 8 feet in length while extendible to approximately between 20 and 35 feet in length, includes a telescoping boom that is capable of loaded angular adjustment from approximately 5 to 15 below horizontal to approximately 75 to 85 above horizontal, and may include a tilt indicator mechanism for displaying unsafe loads and/or angles in combination with loads. Still other advantages and benefits of the invention will become apparent to those skilled in the art upon a reading and understanding of the following summary and detailed description.

In a second embodiment, a similar lift or hoist is defined except that it includes a pivotable connection between the front end loader plate and the lift frame and boom thereon as well as a different wheel and stabilizer configuration plus distinct tow configuration. This new configuration allows for a more compact unit as well as better towing while still assuring safe lifting during its use as a lift or hoist.

### BRIEF DESCRIPTION OF THE DRAWINGS

Preferred embodiment of the invention, illustrative of the best mode in which applicant has contemplated applying the principles, are set forth in the following description and are shown in the drawings and are particularly and distinctly pointed out and set forth in the appended claims.

FIG. 1 is a partial perspective view of one embodiment of the lift mechanism of the present invention taken from a front (hitch end) and side view showing the front end loader attachment plate, removable front wheel, a portion of the boom, and a portion of the rear retractable wheels;

FIG. 2 is a similar partial perspective view of the embodiment of FIG. 1 taken from the opposite side and more clearly showing the removable front wheel;

FIG. 3 is a wide angle front view of the front end loader attachment plate of the embodiment of FIG. 1;

FIG. 4 is an enlarged front view of the front end loader attachment plate portion of the embodiment of FIG. 3;

FIG. 5 is an enlarged perspective view of the base portion of the boom of the embodiment of FIGS. 1-4;

FIG. 6 is an enlarged perspective view of the intermediate portion of the boom of the embodiment of FIGS. 1-5;

FIG. 7 is an enlarged perspective view of the end portion of the boom of the embodiment of FIGS. 1-6;

FIG. 8 is an enlarged partial side view of the upper portion of the body of the lift mechanism showing the electric winch and boom hydraulics, the front end loader hydraulics, and the back side of the front end loader attachment plate;

FIG. 9 is an even further enlarged side view of the upper portion of the body of the lift mechanism of FIGS. 1-8;

FIG. 10 is an enlarged opposite side view as FIG. 8;

FIG. 11 is a back view of one of the retractable legs of the lift mechanism of FIGS. 1-10 further showing the wheel, the retractable leg, the removable lighting mounted on the jack stand, and the wheel lock;

FIG. 12 is a side view of the retractable leg of FIG. 11;

FIG. 13 is a partial (boom section is removed) perspective view of a second embodiment of the lift mechanism of the present invention taken from a back (opposite hitch end) and side view showing the front end loader attachment plate, front wheel, boom support and hydraulics, tow wheels, and outrigger wheels;

FIG. 14 is a partial (boom section is removed) perspective view of the second embodiment of the lift mechanism as shown in FIG. 13 taken from a front (hitch end) and side view showing the removable hitch, back side of the front end loader attachment plate, boom support and hydraulics, tow wheels, and outrigger wheels;

FIG. 15 is a side view of the front end loader attachment plate pivot connection to the frame portion of the second embodiment of the lift mechanism as shown in FIGS. 13 and 14;

FIG. 16 is an enlarged view of one of the tow wheels on the second embodiment as shown in FIGS. 13-15 where the tow wheel is shown in an up position (not engaging the road);

FIG. 17 is a side view of the second embodiment of the lift mechanism as shown in FIGS. 13-16;

FIG. 18 is a schematic showing the boom at five different angles, each at three different extensions, all of which identifies some of the many positions the lift may be placed in;

FIG. 19 is a perspective view of the frame of the second embodiment of FIGS. 13-18;

FIG. 20 is a top view of the frame as shown in FIG. 19;

FIG. 21 is a side view of the frame as shown in FIG. 18;

FIG. 22 is an enlarged view taken at A-A;

FIG. 23 is an enlarged view taken at B-B;

FIG. 24 is a perspective view of a hinge bracket portion of front end loader plate of the second embodiment;

FIG. 25 is a top view of the hinge bracket of FIG. 24; and

FIG. 26 is a side view of the hinge bracket of FIGS. 24-25.

Similar numerals refer to similar parts throughout the drawings.

### DESCRIPTION OF THE PREFERRED EMBODIMENT

First Embodiment

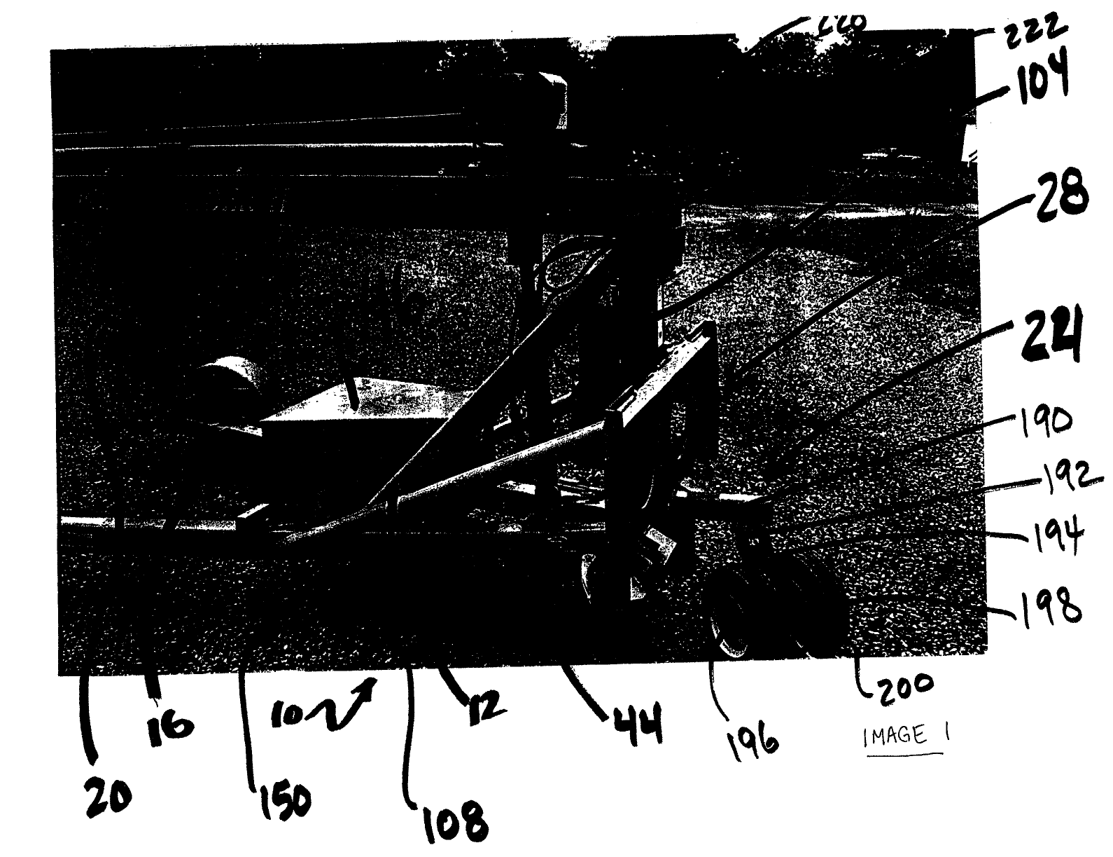

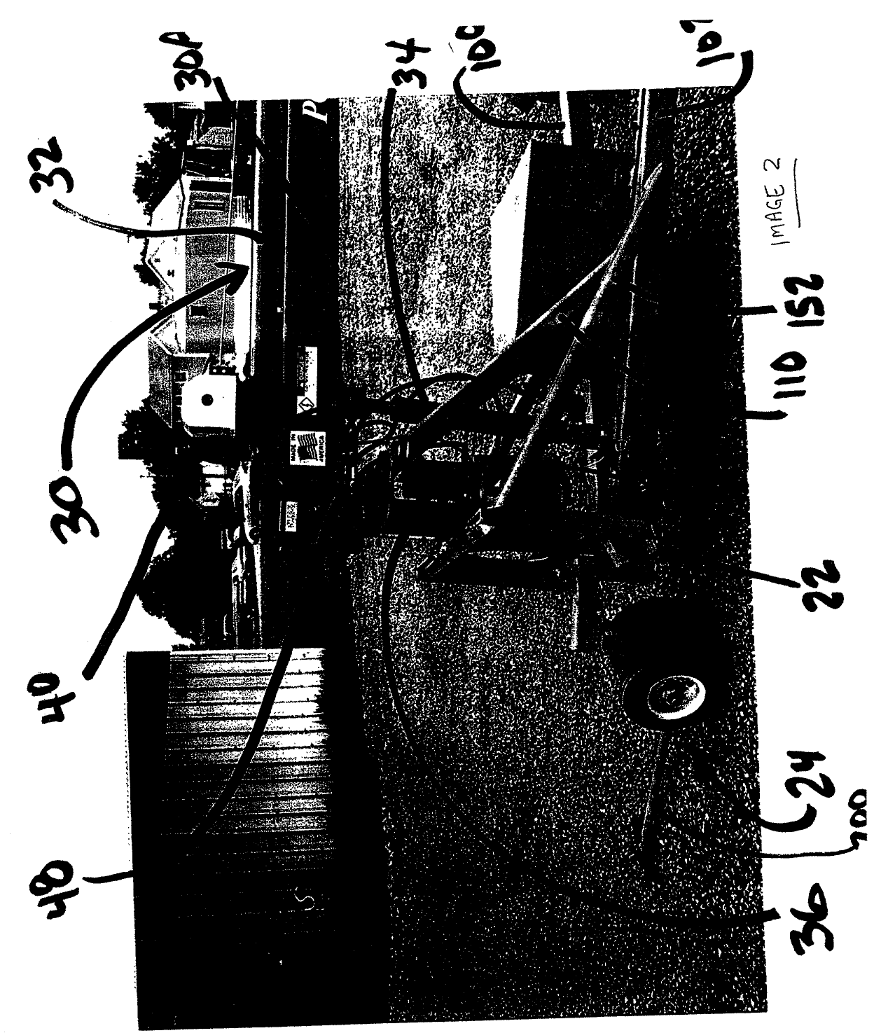

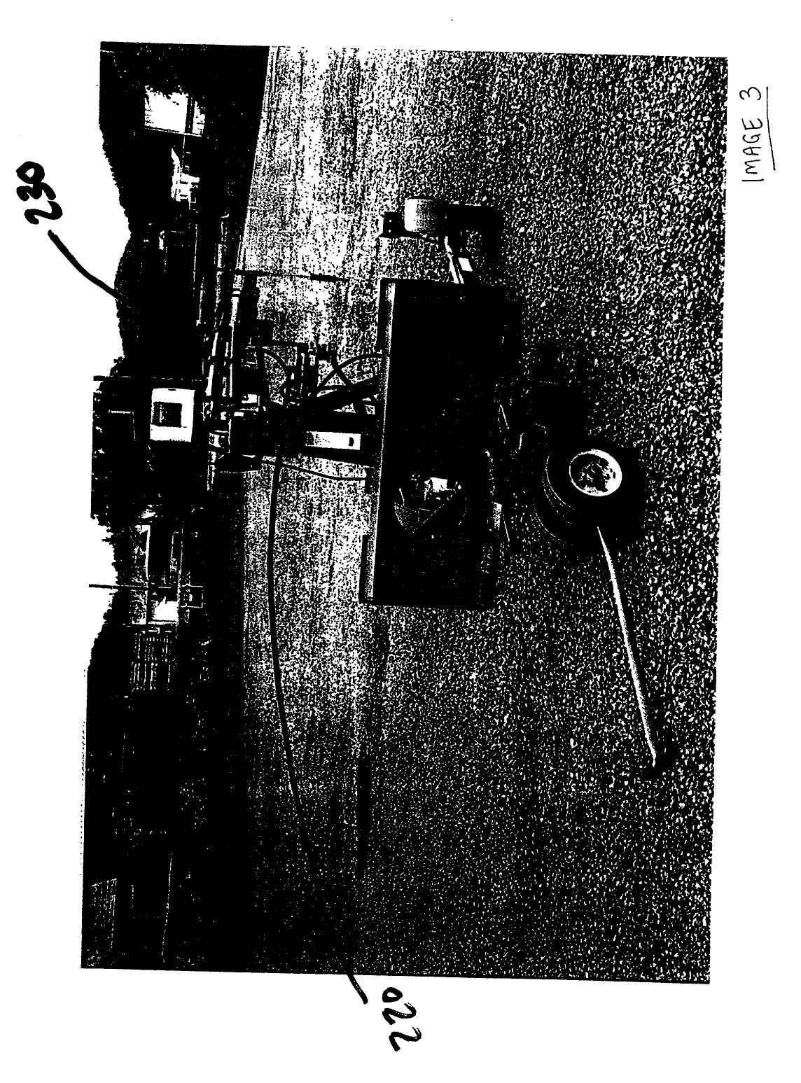

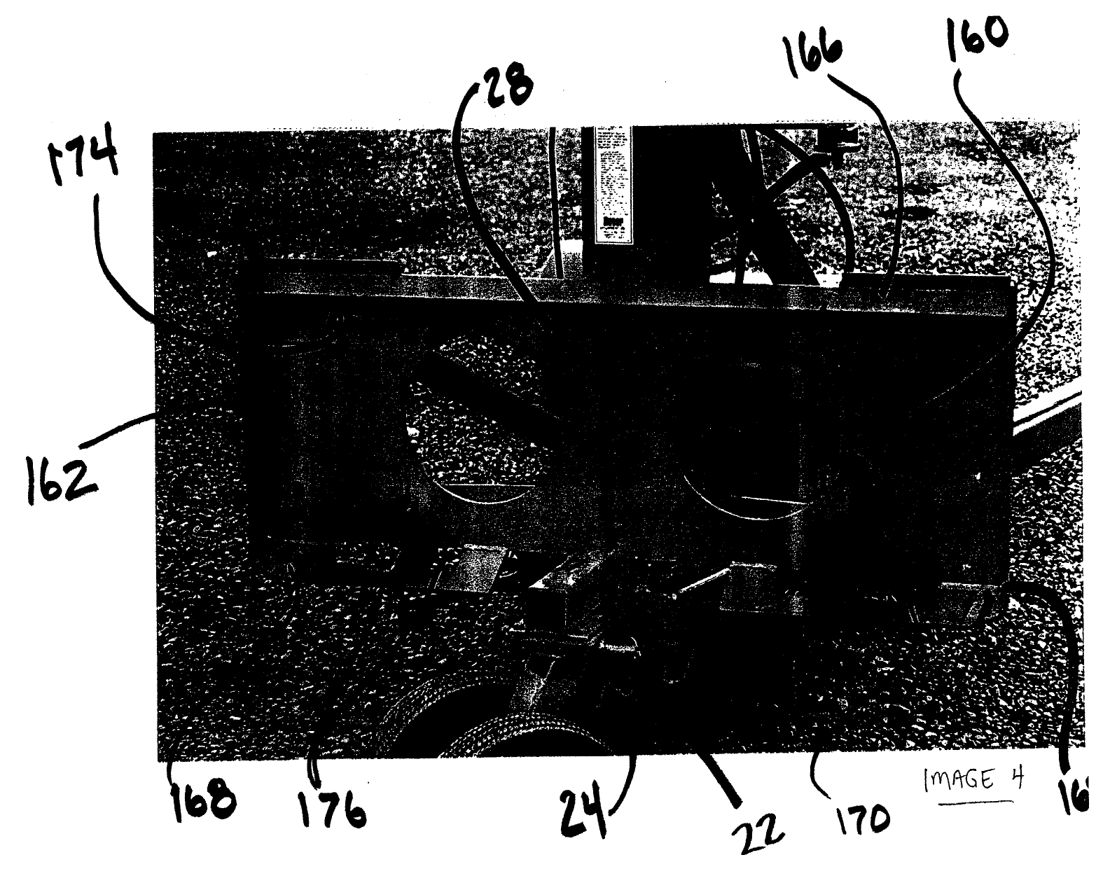

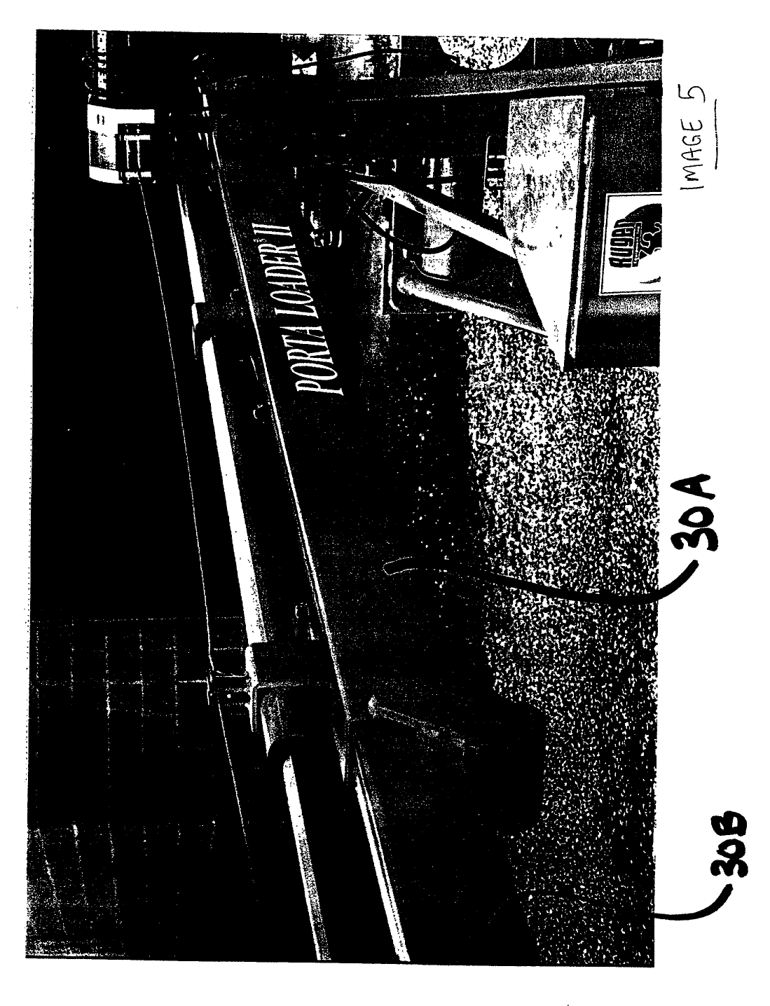

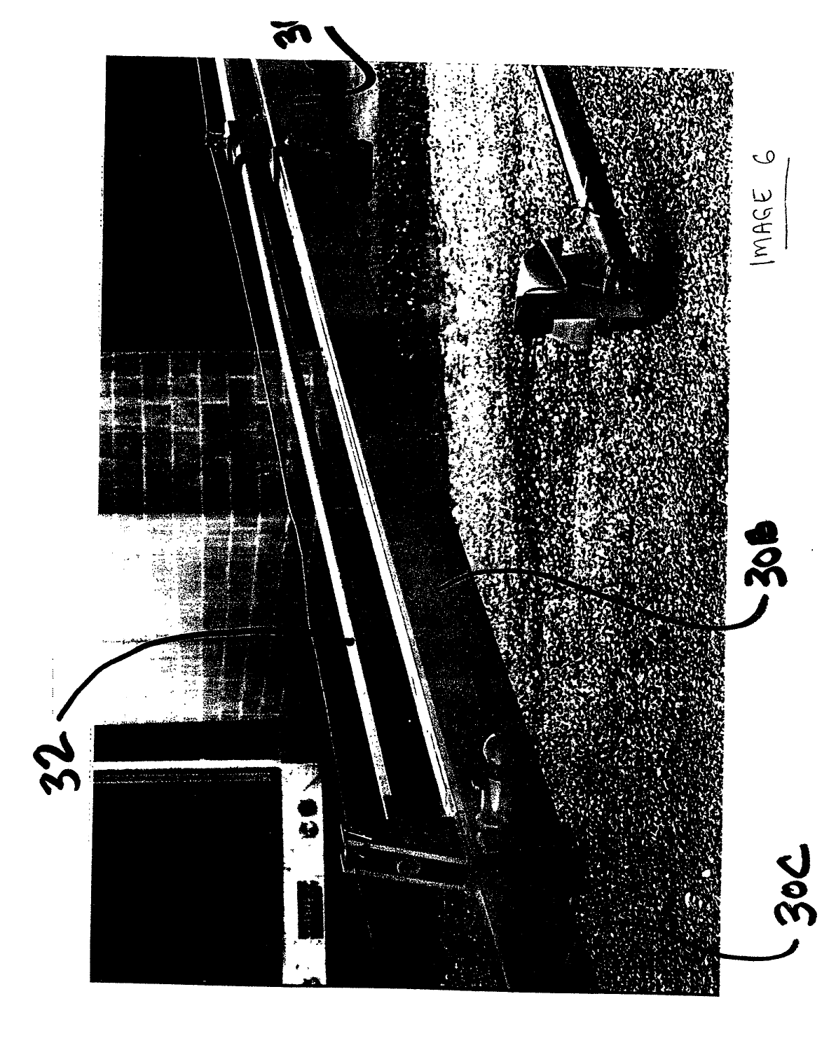

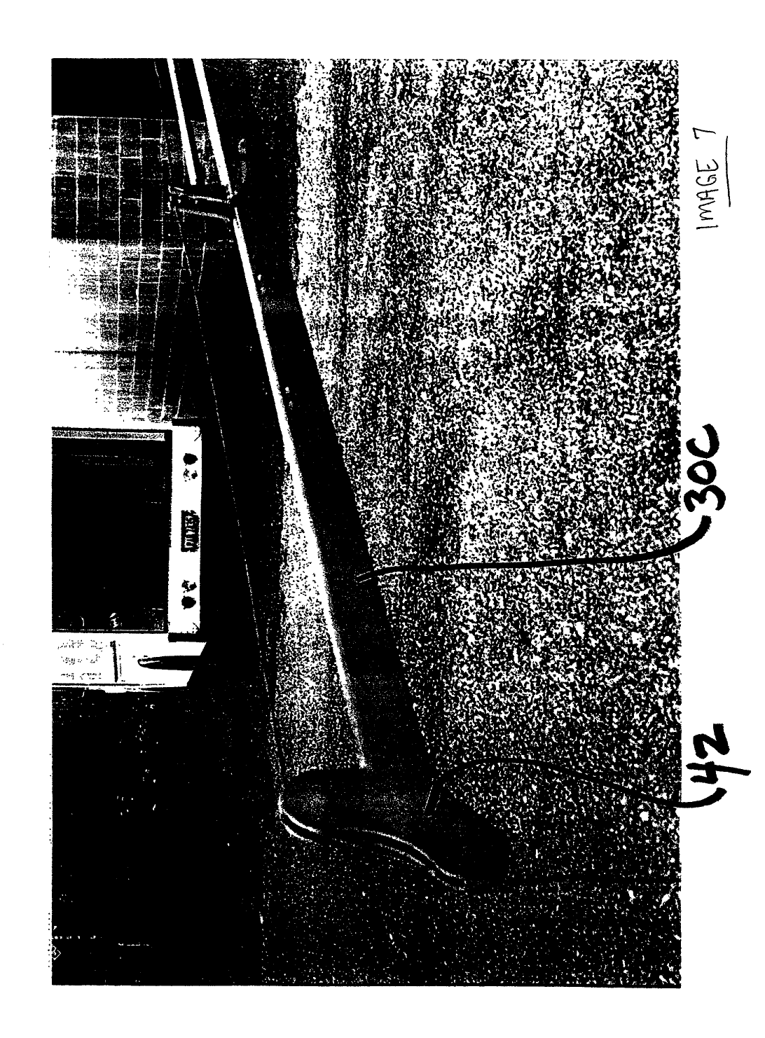

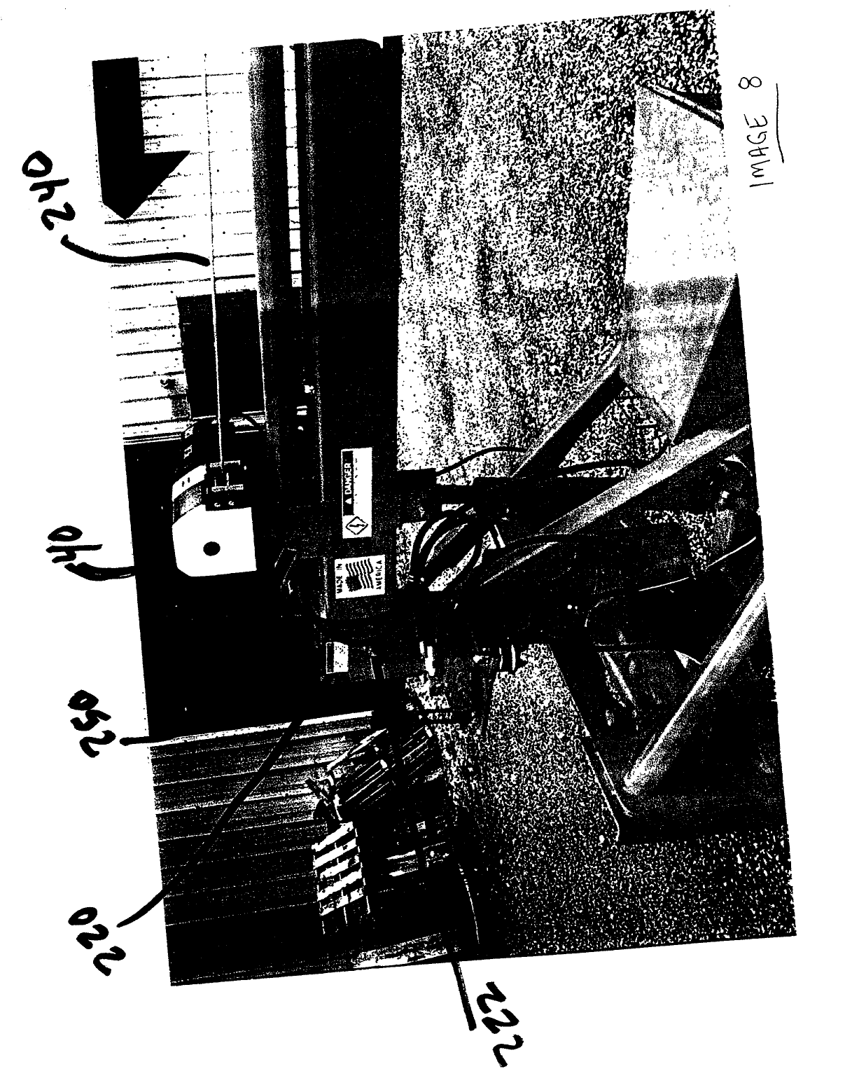

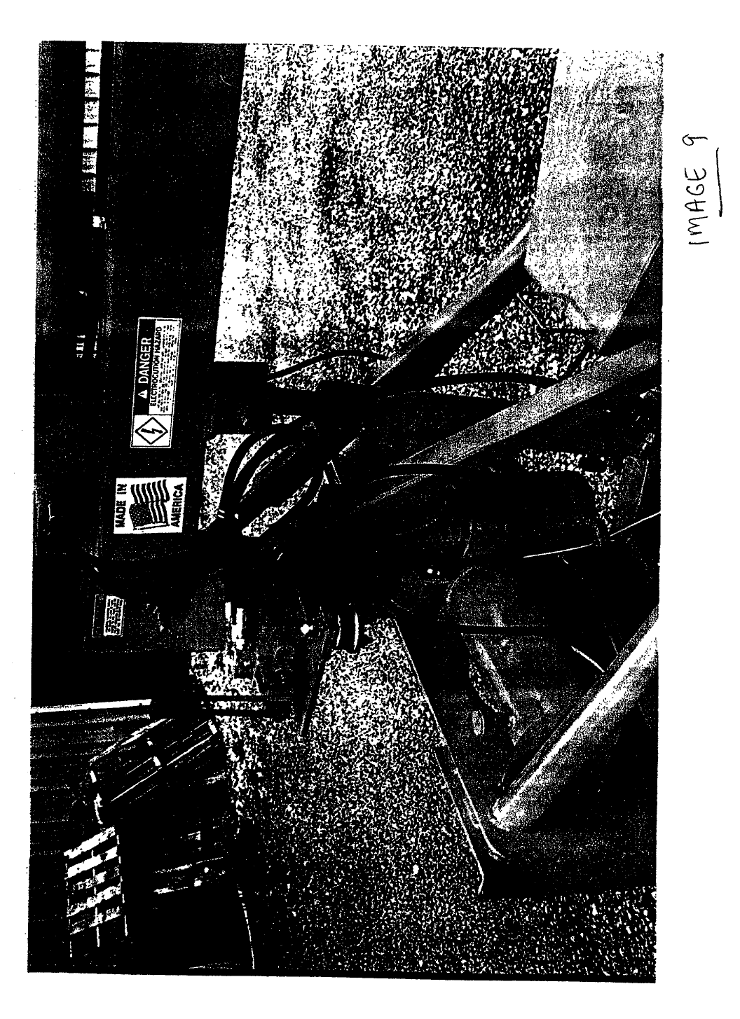

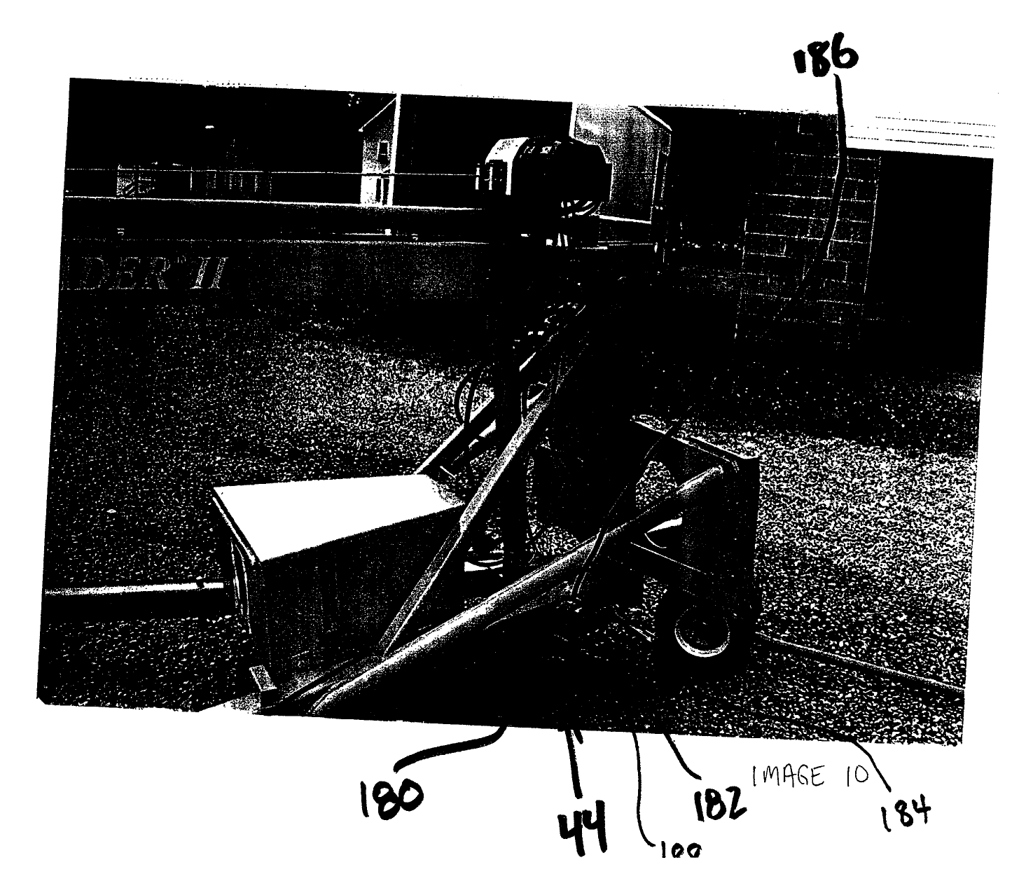

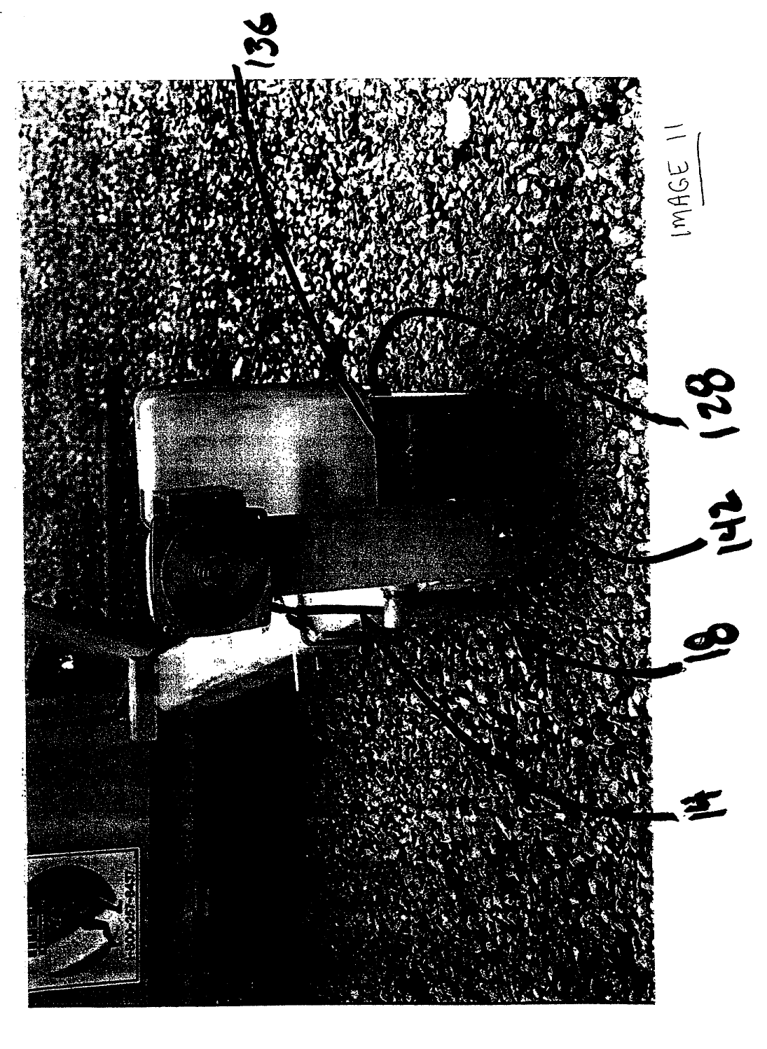

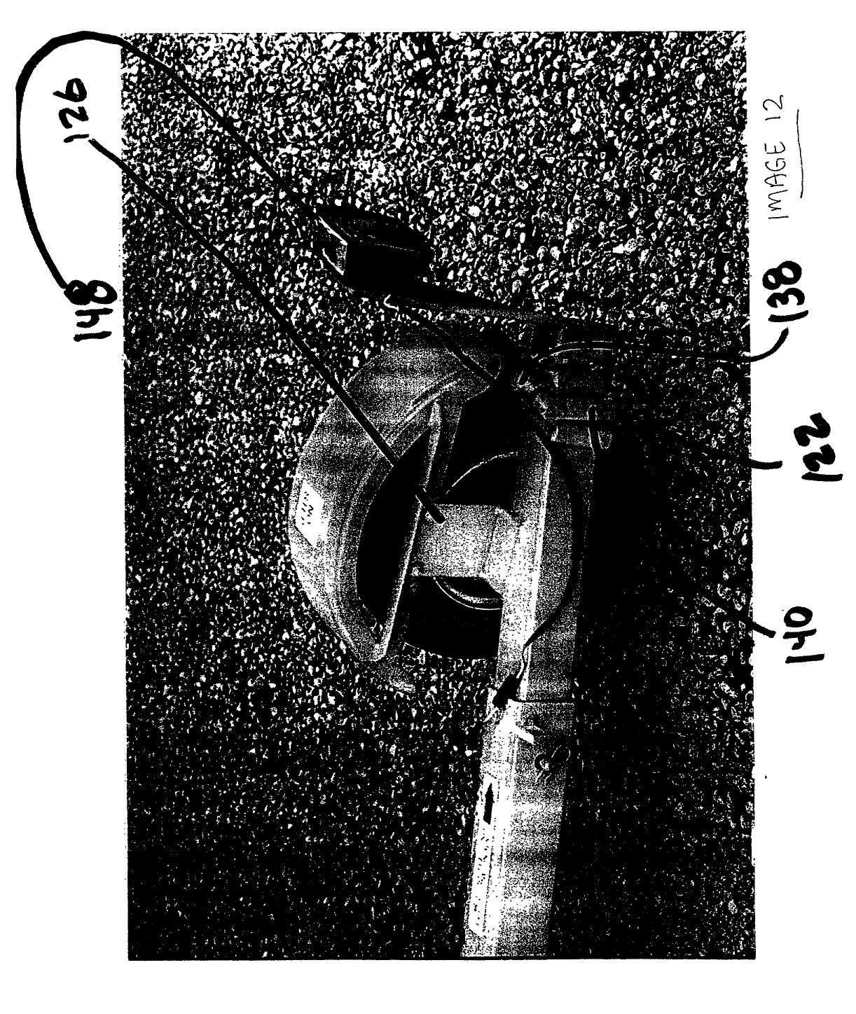

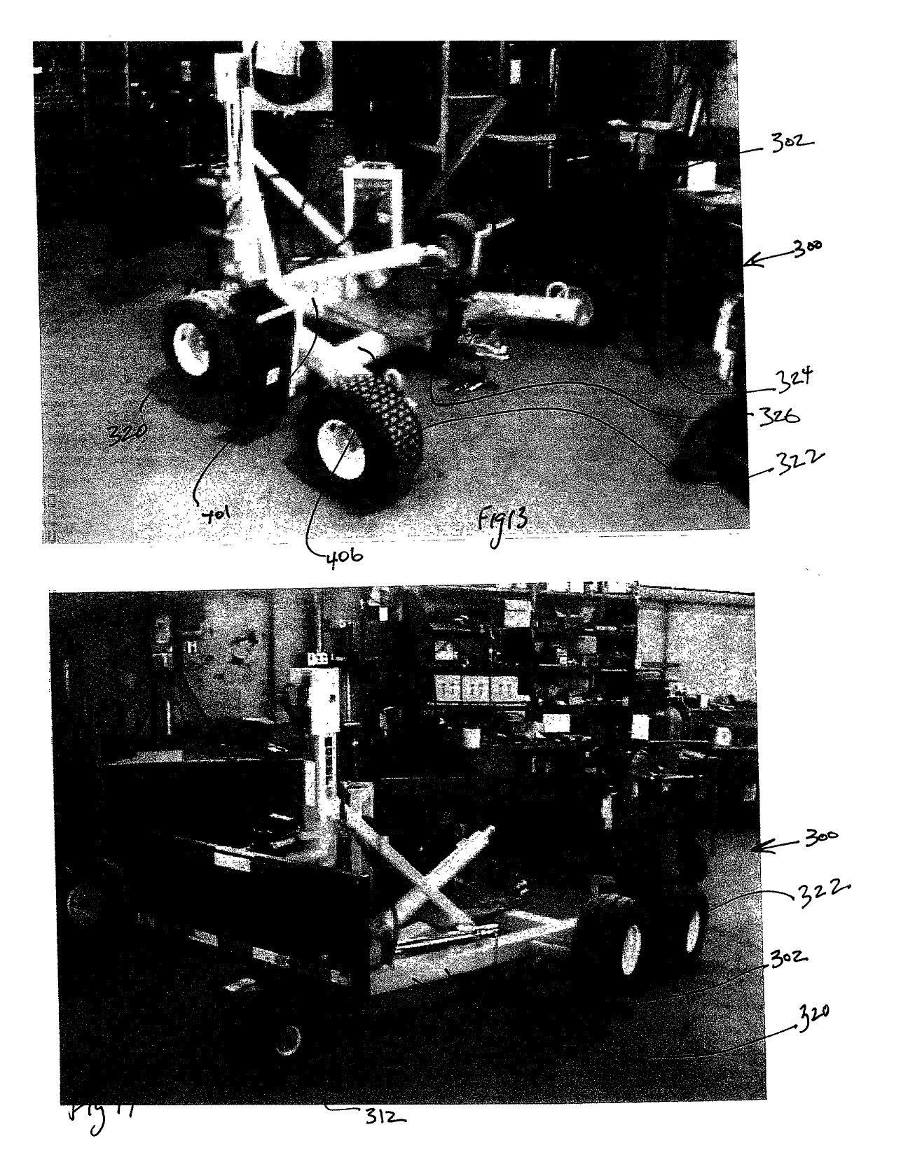

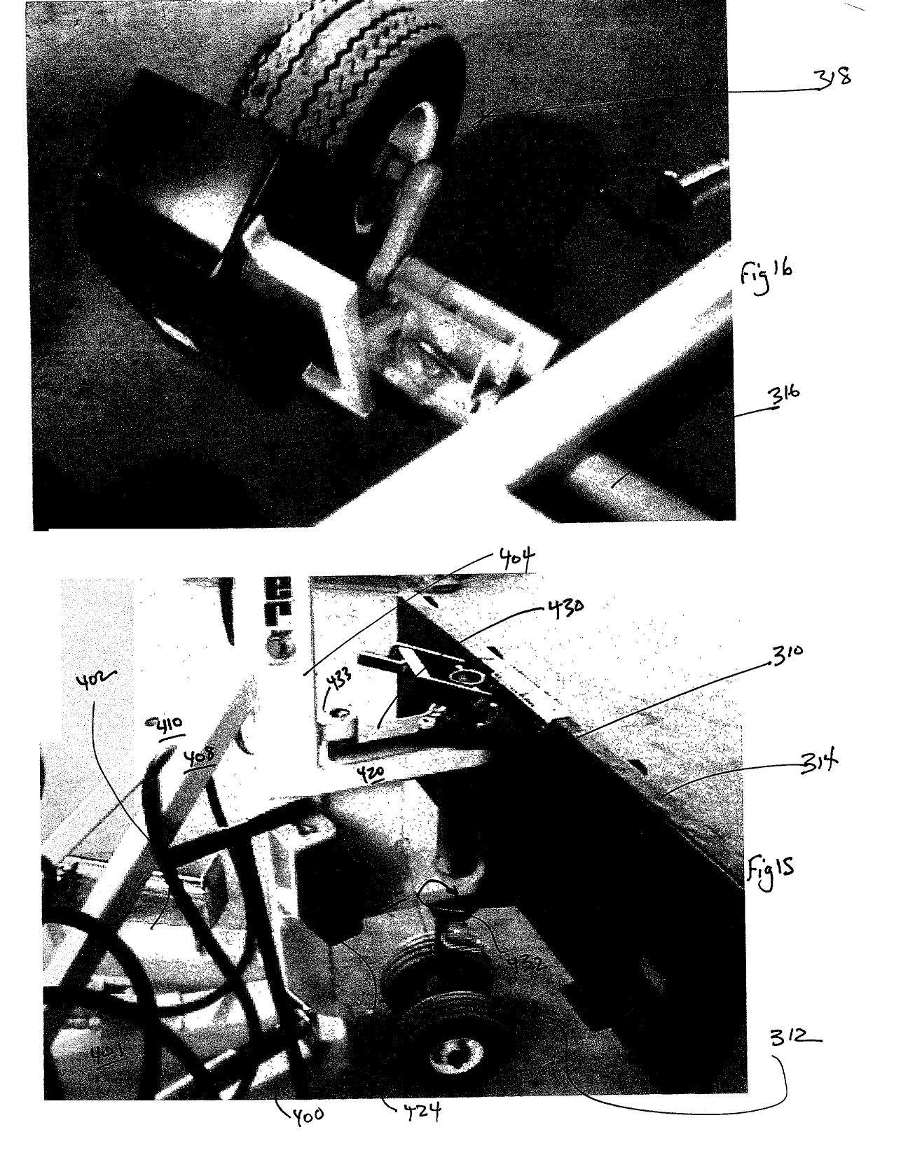

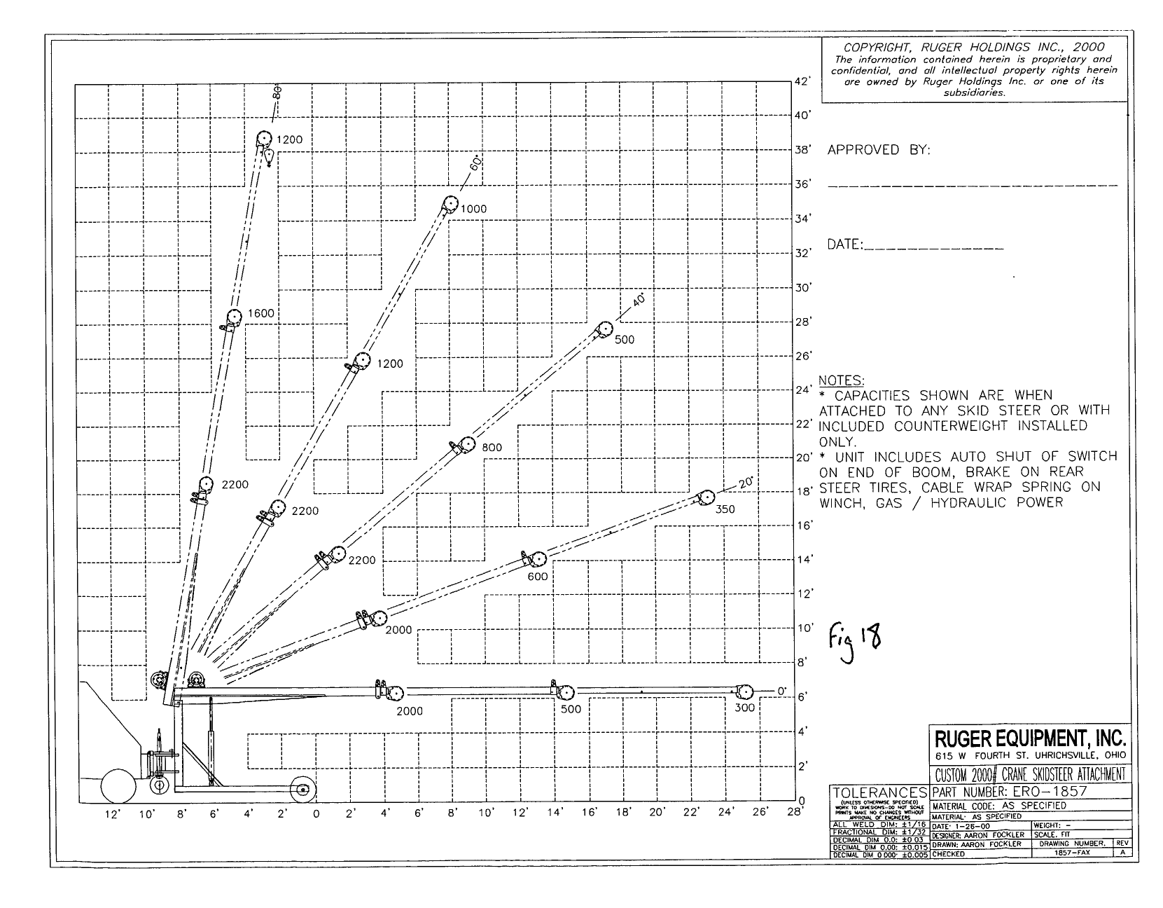

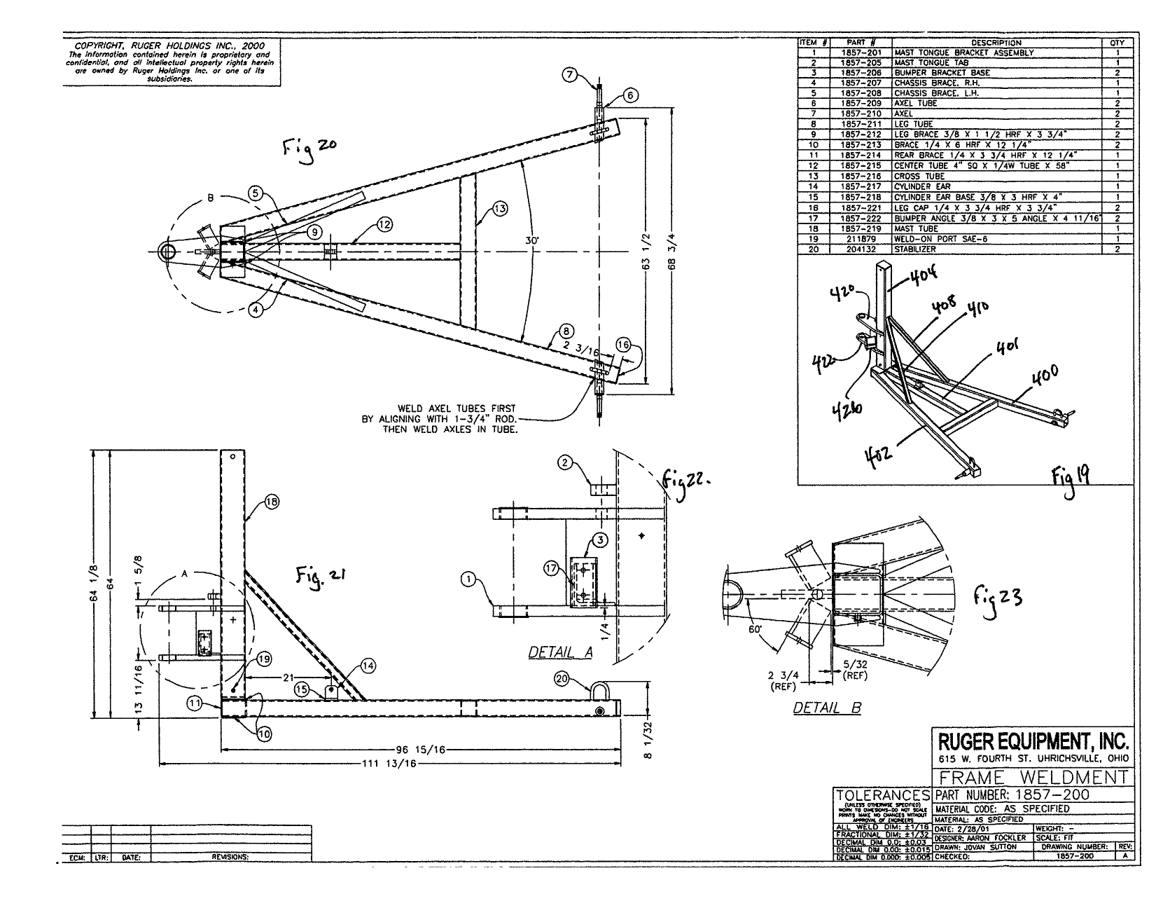

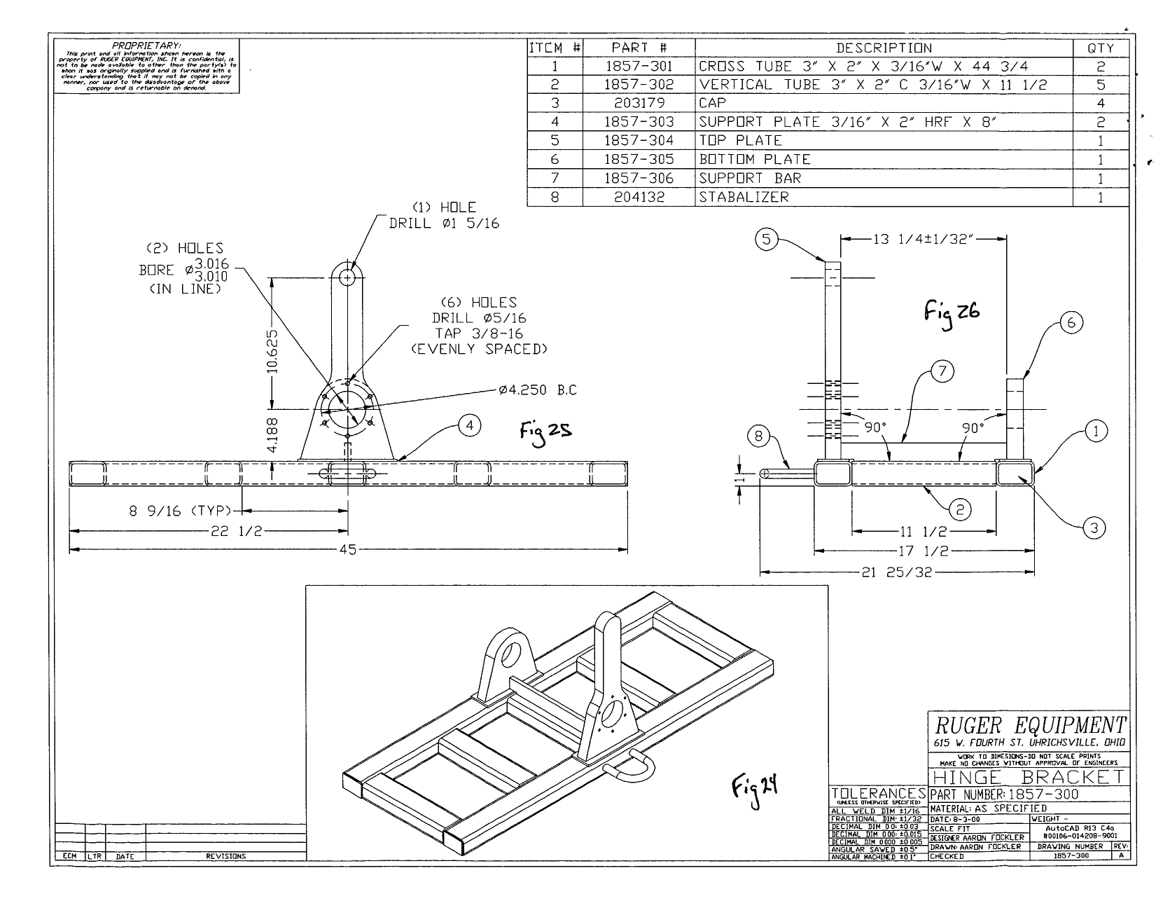

A first embodiment of the improved lift mechanism of the present invention is indicated generally at 10 as is best shown overall in FIGS. 1-4. The lift mechanism 10 is shown generally in perspective in FIGS. 1-4 as including a frame 12, a pair of rear retractable and extendible leg extensions 14 and 16, a rear wheel mechanism 18 and 20 on leg extensions 14 and 16, respectively, a receiver 22 for selectively receiving a front wheel assembly 24 or a tow bar or hitch assembly 26, a front end loader attachment plate 28, a selectively retractable and extendible boom 30 including a plurality of boom sections 30A, 30B, and 30C, and boom extension actuators 32 associated therewith, a boom angle actuator 34, an actuator drive device 36 in communication with the boom extension and boom angle actuators such as by electrical or fluid lines, a power supply 38 in communication with the selected parts of the lift mechanism that need power, a winch 40 with a controller thereon and in communication with the power supply such as by electrical lines, a snatch block 42, at least one stabilizer and/or lift jack 44, tool/supply/battery/etc. box 46, and controls 48.

In the preferred embodiment of the first embodiment as is shown in the Figures, frame 12 includes a pair of substantially horizontal legs 100 and 102, a vertical tower 104, a cross bar 106, and a pair of diagonal cross supports 108 and 110. These legs 100 and 102 are each elongated legs that have a proximate end and a distal end, whereby the proximate ends are near each other and attached approximate a lower end of vertical tower 104 while the distal ends are not as the legs extend away from each other in a v-shape. Cross bar 106 connects the legs 100 and 102 at a point on each of the legs between proximate and distal ends. Vertical tower 104 extends upward from the horizontal legs 100 and 102 where these legs connect at their proximate ends. Cross supports 108 and 110 further define the frame 12 by extending from the legs 100 and 102, respectively, to or near an upper end of the vertical tower 104. Alternatively, frame 12 may be of any design capable of connecting to the loader attachment plate 28, supporting the boom 30, and supplying the necessary structure to receive the receiver 22 and various wheels.

The distal ends of each of the legs 100 and 102 are each designed to cooperate with one of the pair of rear retractable and extendible leg extensions 14 and 16. In the embodiment shown in the Figures, legs 100 and 102 are hollow legs that receive the leg extensions 14 and 16, respectively, such that the leg extensions are adjustable within the leg, and specifically adjustable from nearly entirely slid into the leg (a stored position for towing) to mostly out of the leg (an extended position for optional use during lifting where it adds stability).

Each of the legs 14 and 16 is elongated and includes about its always exposed end the following: a connector 120, a braking mechanism 122, and wheel mechanism (mechanism 18 or 20 for legs 14 and 16, respectively) that includes a wheel frame 126, an axle 128, and a rim and tire 130. In the embodiment shown, the braking mechanism 122 is generally provided to prohibit the unit from moving when the boom extended. One form is a wheel rotation prohibiting mechanism 134 that is provided for each wheel. This wheel rotation prohibiting mechanism 134 includes a main bar 136 rotatably positioned in a sleeve 138 affixed to the leg extension where a leverage bar 140 extends obliquely from the main bar 136. A locking bar 142 is attached to the main bar 136 and is pivotally movable into a wheel locking position where rotation of the wheel is blocked as the locking bar 142 is pinned against the wheel. Another form is a braking mechanism within the actual rim of the wheel such as a drum braking system and this may optionally be placed on every wheel or just the steering or pivot wheel or wheels.

An optional attachable tail-brake-turn signal light assembly 140 is shown attached to the connector 120 via a slide pin connection. This connector 120, when the light assembly is removed, also provides a connection for a jack or support stand when needed or desired to remove weight from the wheel or add additional support to that leg.

At or approximate the connection point or area of horizontal legs 100 and 102, and vertical tower 104, receiver 22 is positioned. Receiver 22 is any means of connecting or receiving the front wheel assembly 24 or the tow bar or hitch assembly 26, or any equivalent structure thereto. In the embodiment shown, receiver 22 is a hollow tube or the like capable of receiving an elongated structure such as the connection arm 190 of the front wheel assembly 24 or the tow bar or hitch assembly 26. In this case the hollow tube is of a square cross section; however, it may be of any known shape as is necessary to receive the front wheel assembly 24 or hitch 26. This receiver concept with the removable front wheel assembly 24 or tow bar or hitch assembly 26 where the receiver is underneath the frame 12 rather than protruding from the frame allows the removal of the assembly 24 or 26 thereby providing an unobstructed access to the front end loader attachment plate 28 as described in more detail below.

The front end loader attachment plate 28 is securely connected to the frame 12, preferably to more than one structure in frame 12 such as to vertical tower 104 and legs 100 and 102 as is shown in the Figures. In this case, the plate 28 is connected horizontally across its bottom portion to the legs 100 and 102 and vertically in the middle to tower 104. The connection is further bolstered by connector bars 150 and 152 which extend from the outer and upper portions to the legs 100 and 102 as is shown in the Figures.

The front end loader attachment plate 28 includes a main surface 160 with opposing side lips 162 and 164, a top lip 166, and a pair of bottom lips 168 and 170. The main surface or plate 160 is the contact surface that the connection plate of the front end loader engages during connection and use. The side lips 162 and 164 extend substantially perpendicularly out from the main surface 160 and function to restrict or hold the connection plate of the front end loader from side to side shifting.

The top lip 166 tapers outward and downward from the main surface 160 to define an acutely angled catch area 174 which corresponds to the load bearing lip on the connection plate of the front end loader. This catch area 174 seats on top of the load bearing lip on the connection plate of the front end loader such that the entire lift mechanism 10 seats on the front end loader (the load bearing lip of the connection plate of the front end loader slides into this acutely angled catch area and lifts the lift 10 therefrom). The weight of the lift 10 and this acutely angled catch area 174 assist in securing the lift 10 to the front end loader.

Additionally, the bottom lip or lips 170 provide a surface against which to lock the lift 10 to the front end loader. As is well known in the front end loader art, front end loaders include hydraulic locking mechanisms for securely grabbing the attachment. The lips 170 are defined so as to cooperate with such locking mechanisms. The lips 170 are tapered outward and downward as shown in the Figures, and include a plurality of voids or holes 176 that correspond to locking pin locations. Once the locking pins are engaged in the holes, the attachment plate 28 is securely mated or held against the connection plate of the front end loader such that the lift 10 moves with the connection plate as directed by the driver of the front end loader.

With each of the legs 14 and 16 including a wheel thereon, the lift 10 requires support at the opposite end, the end where the plate 28 and receiver 22 are located. This support is provided by either the front wheel assembly 24 or the tow bar or hitch assembly 26, or when additional support is desired or a change between assemblies 24 and 26, by stabilizer or lift jacks 44. When it is desired to use the lift 10 in conjunction with a front end loader, the front wheel assembly 24 or the tow bar or hitch assembly 26 must be removed as it is apparent from the Figures that the front wheel assembly 24 or the tow bar or hitch assembly 26 would interfere with attachment of the lift 10 to a front end loader. The stabilizer or lift jacks 44 provide the necessary temporary support while the front wheel assembly 24 or the tow bar or hitch assembly 26 is removed and until the front end loader is connected to the lift 10.

The jacks 44 are connected to the frame 12 approximate the proximate ends of legs 100 and 102 via a connector such as one similar to connector 120 on the distal end of the same legs. The jacks 44 may be screw jacks, hydraulic jacks, or any other jacks capable of lifting. The jacks 44 as shown in the Figures include a base or foot 180, a body 182, a crank 184, a connection device 186, and a lock 188.

Interchangeable with the receiver 22 are front wheel assembly 24 and tow bar or hitch assembly 26. Front wheel assembly 24 is shown in the Figures as including a connection bar or arm 190 (which may be straight or may include a step as is necessary to achieve the desired height so long as at least one end is defined to attach or slide into receiver 22), a pivot plate 192, a main body 194, an axle 196 with one or more rim and wheel assemblies 198 thereon, and a handle 200 for pulling and directing the unit

Tow bar or hitch assembly 26 is any rigid bar insertable within receiver 22 where the rigid bar or tongue is coupled to a hitch assembly for connection to a ball on a tow vehicle.

Lift 10 also includes a selectively retractable and extendible boom 30 including a plurality of boom sections 30A, 30B, and 30C, and boom extension actuators 32 associated therewith. The boom sections are sized and shaped so that section 30C is retractable into section 30B which is retractable into 30A. The boom sections may be of a variety of cross sectional shapes including square as is shown in the Figures, any other polygonal shapes, or even round or oval. The rectangular shape is one of the preferred cross sectional shapes as it is stronger than many other shapes when loaded in a cantilevered manner.

All of the sections may be constructed so as to be hydraulically or manually actuated; however, in the embodiment shown, section 30C is manually actuatable in and out of section 30B, while section 30B is hydraulically actuatable in and out of section 30A. The hydraulic actuation is performed by actuator 32 via its cylinder which is attached to section 30A and hydraulic arm with extends out of the cylinder and is attached to section 30B.

The boom 30 is pivotally connected to the vertical tower 104. Specifically, a connector bracket 220 is rigidly affixed to the top of the vertical tower 104. The end of the boom is slidably inserted into the bracket so that it is pivotable in one direction (up and down) and then a pivot axle or pivot bolt 222 pivotally secures it therein.

The boom is actuated up and down via the boom angle actuator 34. One end of the boom angle actuator 124 (which is preferably a hydraulic cylinder with a drive rod that is actuatable into and out of hydraulic chamber) is pivotally connected at pivot connectors to the boom while the other end of the boom angle actuator is pivotally connected to the frame, in this case at cross support 106.

The actuator drive device 36 in communication with the boom extension and boom angle actuators such as by electrical or fluid lines. It is a hydraulic pump or the equivalent. A set of controls 48 is fluidly connected to it.

Each retractable boom section has a cuff 230 with an eyelet to hold in the lift cable 240 and slider to allow for its free movement during cable or boom movement. The lift cable 240 (that extends from of the winch) extends from winch 40 to snatch block 42 and serves to lift or drop any load attached to the hook on the snatch block.

An alternative embodiment involves lift cable extending through the boom sections rather than affixed on top. This would provide some protection from environmental elements and also assure that should a lift cable snap it will not wildly fly through the air.

Some of the retractable boom sections further include stops that prohibit the complete removal of that boom section from the next largest boom section in which it slides. This functions as a positive safety stop so accidental boom section removal does not occur.

Main boom section 30A also includes a reinforcement bar 250 that supports the winch 40. This bar may be in several pieces welded together with each piece bent or angled so as to best reinforce the boom (this is shown in the figures where the bar is actually several bars welded together). Winch 40 may be either an electric winch or of a hydraulic type (whereby it may be fluidly connected to the actuator drive device 36) or any type of lifting device capable of imparting lifting upon an object. In one version, the winch is a 2,000 pound hydraulic winch which eliminates the need for a snatch block 132.

In the embodiment displayed in the Figures, about the end or nose of boom section 30C is a built-in snatch block 42. The snatch block 42 includes a pair of pulleys 252 and 254 that the lift cable 240 rides on. The pulleys include tabs 256 that prevent the cable from jumping out of the pulleys. The snatch block further serves to provide a doubling effect to the mechanical gain of the lift versus directly hooking the hook to the end of the boom.

The lift 10 also includes a power supply 38 in communication with the selected parts of the lift mechanism that need power.

The lift mechanism 10 is not only portable and towable as described above, it is movable by generally only one person as it is relatively lightweight. In addition, the attachment plate allows for connection of the lift 10 to a front end loader thereby allowing for easier and more rapid movement of the lift from one location to another, or back and forth as is necessary for a repetitive lifting task. The front end loader also provides additional weight to the lift during operation. The attachment to a front end loader further provides the ability to raise the lift or alternatively angle or better position it.

The lift mechanism is readily towed using a standard ball assembly on a vehicle. It is also easy to disassemble should it be desirable to load it into a truck, or move it to a location that is otherwise not attainable by rolling or driving it. For example, this lift mechanism can be disassembled, carried piece by piece inside of a building, and reassembled therein. Also, such disassembly, moving, and reassembly can occur to put the lift mechanism in an otherwise tight, hard to reach, constrained, confined, etc. spot.

One example of a specific embodiment of the above described lift mechanism 10 includes the boom being capable of angular motion from approximately 5 to 10 below horizontal to almost vertical at approximately 75 to 80 above horizontal. The boom when fully retracted is of approximately 4 feet to 8 feet in length while being of approximately 15 feet to 35 feet in length when fully extended using the main boom section and extensions.

Second Embodiment

A second embodiment of the improved lift mechanism of the present invention is indicated generally at 300 as is best shown overall in FIGS. 13-23. The lift mechanism 300 is shown generally in perspective in FIGS. 13-14 as including a frame 302, a shaft 310 pivotably attached to the frame where the shaft includes with a rear wheel mechanism 312 affixed to the lowermost end thereof, a front end loader attachment plate 314 pivotably attached to the shaft 310, a drive axle 316 with drive wheel assembly 318 and 320 thereon where the wheels are pivotable into and out of contact with the surface the lift 330 is on, a pair of front stabilizers embodied as wheel mechanisms 322 and 324, a receiver 326 for selectively receiving a tow bar or hitch assembly 328, a selectively retractable and extendible boom 330 including a plurality of boom sections 330A, 330B, and 330C, and boom extension actuators 332 associated therewith, a boom angle actuator 334, an actuator drive device 336 in communication with the boom extension actuators and boom angle actuators such as by electrical or fluid lines, a power supply 338 in communication with the selected parts of the lift mechanism that need power, a winch 340 with a controller thereon and in communication with the power supply such as by electrical lines, at least one stabilizer and/or lift jack 344, and controls 348.

In the preferred embodiment of the second embodiment as is shown in the Figures, frame 302 includes a pair of substantially horizontal legs 400 and 402 (an optionally a third leg 401 therebetween), a vertical tower 404, a cross bar 406, and a pair of diagonal cross supports 408 and 410. These legs 400, 401 and 402 are each elongated legs that have a proximate end and a distal end, whereby the proximate ends are near each other and attached approximate a lower end of vertical tower 404 while the distal ends are not near each other as the legs 400 and 402 extend away from each other in a v-shape (with leg 401 extending approximately in the middle of the V between the two other legs in a bisecting manner). Cross bar 406 connects the legs 400, 401 and 402 at a point on each of the legs between the proximate and distal ends. Vertical tower 404 extends upward from the horizontal legs 400, 401 and 402 where these legs connect at their proximate ends. Alternatively, frame 302 may be of any design capable of connecting to the loader attachment plate 314, supporting the boom 330, and supplying the necessary structure to receive the receiver 326 and the various wheels and axles.

In more detail, tower 404 of frame 302 also includes a pair of outwardly extending brackets 420 and 422 that are parallel to each other and include shaft receiving holes therein. Pivot stops 424 and 426 are also attached to tower 404 and function to stop the pivoting of the lift 300 about the shaft when one of the stops meets the plate.

Attached to the frame at the distal ends of each of the legs 400 and 402 are one of the pair of front stabilizers 322 and 324 which are shown as wheels. These wheels 322 and 324 are connected to the legs via axles or shafts that allow for the free rotation of the wheels. In the most preferred embodiment, the wheels are filled with foam, rubber, polymers or other like filler substances that provide a less compressible reaction to load than air while providing more compression than rigid jack stands or the like. These legs 400 and 402 and the wheels 322 and 324 thereon are for frame stabilization during loading, and are not intended for transporting the vehicle which is accomplished on wheels 318 and 320 (although transportation on wheels 322 and 324 is feasible and contemplated hereunder).

Although in the preferred embodiment the legs are one piece and rigid in length; optionally, retractable and extendible leg extensions may be provided whereby the legs receive such extensions as described above in the first embodiment. In general, the legs 400 and 402 in this optional embodiment are hollow legs that receive the leg extensions such that the leg extensions are adjustable within the leg, and specifically adjustable from nearly entirely slid into the leg (a stored position for towing) to mostly out of the leg (an extended position for optional use during lifting where it adds stability). In this case the wheels 322 and 324 would be positioned on the extensions and not the legs.

At the distal or outermost end (opposite the end connected to the tower and beyond the cross bar) of the center leg 401, the receiver 326 is positioned. Receiver 326 is any means of connecting or receiving the tow bar or hitch assembly 328, or any equivalent structure thereto. In the embodiment shown, center leg 401 is hollow such that at its distal or outermost end defines itself as a square or other like receiver 326 for slidably receiving tow bars, hitch tongues or the like. A pin or other locking mechanism is used via a hole in the leg that is aligned with one of the holes on the tow bar to lock the tow bar as needed at various locations including: fully or almost fully retracted (as shown in FIGS. 13-14) as is used for storage, partially or fully extended as is needed for towing, etc.

The front end loader attachment plate 314 is securely but pivotably connected to the frame 302. Preferably plate 302 comprises a front end loader attachment structure 302A welded or connected to a hinge bracket 302B all of which is shown in FIGS. 13-14 and 24-26. The hinge bracket includes substantially planer frame structure with a pair of outwardly extending flanges or yokes 430 and 432 (flange 430 is the upper flange and it is significantly longer) that are parallel to each other and include shaft receiving holes therein. The holes in the pair of outwardly extending brackets 420 and 422 and the holes in flanges 430 and 432 are aligned as shown in FIGS. 13-14 whereby shaft 310 is positioned within the holes. This secures the front end loader attachment plate 314 to the frame 302 in a pivotable manner. In addition, the wheel mechanism 312 on the lowermost end of the shaft supports the rear portion of the overall lift including the plate 314 and tower end of the frame. As a result, the frame, boom, etc. are pivotable about this shaft in relation to the plate 314 when rigidly attached to a front end loader.

Such pivoting is accomplished by when driving the front end loader whereby the lift which is resting on wheels 312, 322 and 324 (but not 318 and 320). The effect is that the lift may be steered into place since it is pivotable.

As is apparent from FIG. 15, the upper flange 430 is significantly longer than the lower flange 432. It extends outward to the vertical tower where a locking ear 433 extends outward. When it is desirable to prohibit pivoting (generally pivoting is only desirable when steering the unit into place), a pin is inserted through aligned holes in upper flange 430 and ear 433 which prohibits pivoting and forces the front end loader and lift to be aligned.

A bracket 440 is attached to the top of shaft 310 as best shown in FIG. 15. This bracket 440 is pivotably pinned to the top of the shaft at one end and allows for steering or pivoting of the lift when a front end loader is not attached.

The front end loader attachment structure 302A includes a main surface with opposing side lips and, a top lip, and a pair of bottom lips as shown in the first embodiment described above. As described above the top lip tapers outward and downward from the main surface to define an acutely angled catch area which corresponds to the load bearing lip on the connection plate of the front end loader. This catch area seats on top of the load bearing lip on the connection plate of the front end loader such that the entire lift mechanism seats on the front end loader (the load bearing lip of the connection plate of the front end loader slides into this acutely angled catch area and lifts the lift therefrom). The weight of the plate and lift and this acutely angled catch area assist in securing the lift to the front end loader. Additionally, the bottom lip or lips provide a surface against which to lock the lift to the front end loader. As is well known in the front end loader art, front end loaders include hydraulic locking mechanisms for securely grabbing the attachment. The lips are defined so as to cooperate with such locking mechanisms. The lips are tapered outward and downward as shown in the Figures, and include a plurality of voids or holes that correspond to locking pin locations. Once the locking pins are engaged in the holes, the attachment plate is securely mated or held against the connection plate of the front end loader such that the lift moves with the connection plate as directed by the driver of the front end loader.

Drive axle 316 as is shown in the Figures is positioned on the frame in between rear wheel mechanism 312 and front stabilizers 322 and 324. Drive axle 316 is an elongated rigid structure affixed to the frame and extending across the bottom of it as shown in the FIGS. 13-16. At each end of the axle 316 is a drive wheel assembly 318 and 320. Each drive wheel assembly includes a wheel 460, a lock body 462 attachable to the axle 316, a pivot arm 464 pivotably connected to the wheel at one end and securely connected to the lock body at the other end. Lock body 462 includes a sleeve that slides over the axle and is movable around the axle. A pin secures the lock body and thus the wheel to the axle in multiple positions (one position is a stored position as is shown in FIG. 16 where the wheel is stored up away from the surface the lift is on, while a second position is a tow position where the wheel is rotated down from the stored position until it engages the surface and the lift is supported only by the wheels 460 and hitch or two bar and not the wheels 312, 322 and 324). Lock body may further include fenders to cover the wheels and/or tail and brake lights.

Stabilizer or lift jacks are also preferably provide for two purposes: one to provide extra temporary support if needed, and two to lift the front stabilizers 322 and 324 off of the surface the unit is on and sufficiently up in the air to allow the lock body 462 to be pivoted from a stored position to a tow position or vice versa.

The jacks are connected to the frame wherever a connector such as one similar to connector 120 described above. In this embodiment, connectors are provided on the tow bar or frame and may be screw jacks, hydraulic jacks, or any other jacks capable of lifting.

Tow bar or hitch assembly is any rigid bar insertable within receiver where the rigid bar or tongue is coupled to a hitch assembly for connection to a ball on a tow vehicle.

Lift 300 also includes a selectively retractable and extendible boom 330 including a plurality of boom sections 330A, 330B, and 330C, and boom extension actuators 332 associated therewith, all substantially similar or identical to those of the first embodiment described above. The boom sections are sized and shaped so that section 330C is retractable into section 330B which is retractable into 330A. The boom sections may be of a variety of cross sectional shapes including square as is shown in the Figures, any other polygonal shapes, or even round or oval. The rectangular shape is one of the preferred cross sectional shapes as it is stronger than many other shapes when loaded in a cantilevered manner.

All of the sections may be constructed so as to be hydraulically or manually actuated. The boom 30 is also pivotally connected to the vertical tower 404 in a substantially similar or identical manner to that described above for the first embodiment.

The boom is actuated up and down via the boom angle actuator 334. One end of the boom angle actuator (which is preferably a hydraulic cylinder with a drive rod that is actuatable into and out of hydraulic chamber) is pivotally connected at pivot connectors to the boom while the other end of the boom angle actuator is pivotally connected to the frame.

The actuator drive device 336 in communication with the boom extension and boom angle actuators such as by electrical or fluid lines. It is a hydraulic pump or the equivalent. A set of controls is fluidly connected to it.

Each retractable boom section has a cuff with an eyelet to hold in the lift cable and slider to allow for its free movement during cable or boom movement. The lift cable (that extends from of the winch) extends from winch 340 to a snatch block/hook mechanism or just a hook or like fastener and serves to lift or drop any load attached to the hook on the snatch block.

An alternative embodiment involves lift cable extending through the boom sections rather than affixed on top. This would provide some protection from environmental elements and also assure that should a lift cable snap it will not wildly fly through the air.

Some of the retractable boom sections further include stops that prohibit the complete removal of that boom section from the next largest boom section in which it slides. This functions as a positive safety stop so accidental boom section removal does not occur.

Winch 340 may be either an electric winch or of a hydraulic type (whereby it may be fluidly connected to the actuator drive device 336) or any type of lifting device capable of imparting lifting upon an object. In one version, the winch is a 2,000 pound hydraulic winch which eliminates the need for a snatch block.

The lift also includes a power supply 338 in communication with the selected parts of the lift mechanism that need power.

In use, a front end loader is connected to the lift. At this point wheels 312, 322 and 324 (but not 318 and 320) are on the ground or other surface the unit is setting on. The front end loader is driven such that the lift attached thereto is pushed to wherever the loader is going. Because of the pivot, the lift may be steered. Once properly positioned, the front end loader typically remains attached because it provides significant extra weight to balance the lift (however, such is not necessary as the lift may be operated on its own once positioned). Stabilizer jacks may also be used if desired. The lift and front end loader are now aligned and pinned to prevent pivoting

The object to be lifted is attached to the end of the boom, and the boom is actuated to the height and angle needed. Once all lifting is done, the boom is retracted in and positioned at horizontal. All of the boom movement is accomplished by hydraulics, or electrical ball screws or actuators, or manually if desired.

The pin preventing pivoting is removed and lift is then movable using the front end loader such that it is removed from the specific position. It may again be necessary here to steer the unit.

If it is desired to tow the unit, stabilizer jacks are used to lift the lift, whereby the tow wheels are pivoted down into tow position. The rear wheel is also removed (it is pinned in position so the pin is removed and the wheel slides out of the shaft). The tow bar is unpinned, slid out, and re-pinned to secure it in an extended or towing position. The tow bar is connected to a vehicle and the stabilizer jacks are removed. The lift is now supported by the tow wheels and the hitch or tow bar. After towing this process is reversed. The order in which the stabilizer jacks are used, tow wheels moved from stored to on the ground or vice versa, and the tow bar is connected may be varied depending upon stabilizer jack location, etc.

The lift mechanism 300 is not only portable and towable as described above, it is movable efficiently by a front end loader particularly due to the pivot mechanism around the shaft which more readily allows for the lift to be properly positioned and/or moved via steering of it. The front end loader also provides additional weight to the lift during operation. The attachment to a front end loader further provides the ability to raise the lift or alternatively angle or better position it.

The lift mechanism is readily towed using a standard ball assembly on a vehicle. The front stabilizers embodied as wheels filled with foam, rubber or the like provide for a very stable operation when coupled with the rear wheel or a front end loader; however the front stabilizers and rear wheel are readily lifted off of the ground by a stabilizer jack to allow the drive wheels (which are positioned more in the center of the vehicle for better weight distribution) to be rotated into a tow position to tow the vehicle and the tow bar to be raised to the proper height for towing. This also provides for a very low center of gravity when the drive wheels are pivoted up and the unit is resting on the front stabilizers which places the frame near to the ground.

It is also easy to disassemble should it be desirable to load it into a truck, or move it to a location that is otherwise not attainable by rolling or driving it. For example, this lift mechanism can be disassembled, carried piece by piece inside of a building, and reassembled therein. Also, such disassembly, moving, and reassembly can occur to put the lift mechanism in an otherwise tight, hard to reach, constrained, confined, etc. spot.

One example of a specific embodiment of the above described lift mechanism 300 includes the boom being capable of angular motion from approximately 5 to 10 degrees below horizontal to almost vertical at approximately 75 to 85 degrees above horizontal. A more specific example is shown in FIG. ______ where the range is from horizontal to 80 degrees above horizontal with the lift capabilities with safety factors built in being shown at various angles and boom extensions.

Accordingly, the lift mechanism is simplified, provides an effective, safe, inexpensive, and efficient device which achieves all the enumerated objectives, provides for eliminating difficulties encountered with prior devices, and solves problems and obtains new results in the art.

In the foregoing description, certain terms have been used for brevity, clearness and understanding; but no unnecessary limitations are to be implied therefrom beyond the requirement of the prior art, because such terms are used for descriptive purposes and are intended to be broadly construed.

Moreover, the description and illustration of the invention is by way of example, and the scope of the invention is not limited to the exact details shown or described.

Having now described the features, discoveries and principles of the invention, the manner in which the improved lift mechanism is constructed and used, the characteristics of the construction, and the advantageous, new and useful results obtained; the new and useful structures, devices, elements, arrangements, parts and combinations, are set forth in the appended claims.

We claim:

1. A lift mechanism that is towable and connectable to a front end loader, comprising:
a frame having a telescopic boom attached thereto;
an attachment plate rigidly connected to the frame and configured to provide secure attachment of the lift mechanism to a front end loader;
a pair of substantially horizontally retractable and extendible leg extensions extending from the frame approximately opposite the attachment plate, each leg having a proximate end rigidly connected to the frame and a distal end including a wheel; and
a receiver connected to the frame approximately opposite the legs, the receiver for selectively receiving one of a front wheel assembly, a tow bar, and a hitch assembly when the lift mechanism is disconnected from a front end loader.

2. A lift mechanism that is towable and connectable to a front end loader, comprising:
a frame having a telescopic boom attached thereto, and includes a pair of substantially horizontal legs, and a vertical tower connected to the legs and extending vertically therefrom, and wherein the pair of substantially horizontal legs are connected at one end and define a V;
an attachment plate rigidly connected to the frame and configured to provide secure attachment of the lift mechanism to a front end loader;
a pair of substantially horizontally retractable and extendible leg extensions extending from the frame approximately opposite the attachment plate, each leg having a proximate end rigidly connected to the frame and a distal end including a wheel; and

3. The lift mechanism of claim 2 wherein the frame further includes a cross bar connecting the legs about a mid-section of the legs, and a pair of diagonal cross supports connecting the legs to an upper end of the vertical tower.

4. A lift mechanism that is towable and connectable to a front end loader, comprising:
a frame having a telescopic boom attached thereto; and
an attachment plate pivotably connected to the frame and configured to provide secure attachment of the lift mechanism to a front end loader.

5. The lift mechanism of claim 4 further comprising a shaft that the frame is pivotably connected to and the attachment plate is pivotably connected to.

6. The lift mechanism of claim 4 wherein the frame includes a pair of brackets extending therefrom, and the attachment plate includes a pair of flanges extending therefrom, and the brackets and flanges are each pivotably connected to a shaft.

7. The lift mechanism of claim 5 wherein at least one wheel is affixed to the shaft.

8. The lift mechanism of claim 4 wherein the frame includes a pair of substantially horizontal legs, and a vertical tower connected to the legs at a proximate end of the legs and extending vertically therefrom.

9. The lift mechanism of claim 8 wherein at least one wheel is attached approximate a distal end of the legs that is opposite the proximate end.

10. The lift mechanism of claim 9 wherein the wheels are filled with one of the group of foam, rubber and polymers.

11. The lift mechanism of claim 4 wherein a plurality of wheels support the frame and are filled with one of the group of foam, rubber and polymers.

12. The lift mechanism of claim 4 wherein an axle is attached to the frame and includes a wheel at each end thereof, each wheel being pivotable from a storage position to a surface engaging position.

13. The lift mechanism of claim 4 wherein an axle is attached to the frame and includes a tow wheel at each end thereof, each tow wheel being pivotable from a storage position to a surface engaging position.

14. The lift mechanism of claim 13 further comprising a shaft and wherein the frame includes a pair of brackets extending therefrom, and the attachment plate includes a pair of flanges extending therefrom, and the brackets and flanges are each pivotably connected to the shaft which includes at least one shaft wheel affixed thereto.

15. The lift mechanism of claim 14 wherein the frame includes a pair of substantially horizontal legs, and a vertical tower connected to the legs at a proximate end of the legs and extending vertically therefrom wherein at least one leg wheel is attached approximate a distal end of the legs that is opposite the proximate end and wherein the leg wheels are filled with one of the group of foam, rubber and polymers.

16. The lift mechanism of claim 4 wherein the telescoping boom includes a plurality of boom sections and where the telescoping boom is pivotally attached approximate an upper end of the vertical tower.
